(19) United States
(12) Patent Application Publication
(10) Pub. No.: US 2025/0100194 A1
(43) Pub. Date: Mar. 27, 2025

(54) METHOD AND INJECTION MOULD FOR PRODUCING A PRODUCT FROM AN INSERT AND PLASTIC BODY INJECTION-MOULDED THEREON

(71) Applicant: FOSTAG Formenbau AG, Stein am Rhein (CH)

(72) Inventor: Rolf MÜHLEMANN, Schlattingen (CH)

(73) Assignee: FOSTAG Formenbau AG, Stein am Rhein (CH)

(21) Appl. No.: 18/725,962

(22) PCT Filed: Nov. 29, 2022
(86) PCT No.: PCT/CH2022/050034

§ 371 Date: Jul. 1, 2024

(30) Foreign Application Priority Data
Jan. 6, 2022 (CH) CH000025/2022

(51) Int. Cl. B29C 45/14; B29C 45/27; B29C 45/37; B29L 31/00

(52) U.S. Cl. CPC B29C 45/14336; B29C 45/2708; B29C 45/376; B29L 2031/712

(57) ABSTRACT

A method for producing a product comprising an insert part with an edge reinforced by a plastic body injection-moulded onto the edge includes: providing an injection moulding tool comprising a cavity, a cavity-forming wall formed by a movable tool part which is movable such that when the movable tool part is moved away, a volume of the cavity is released; inserting the insert into the injection moulding tool such that the edge region to be injection-moulded is arranged in the cavity of the injection moulding tool; injecting plastic melt into the cavity so that it flows against a lateral surface facing away from the movable tool part, and presses another lateral surface of the edge region facing the movable tool part against the movable tool part until the cavity is filled with the plastic melt; and moving the movable tool part away and filling the released volume of the cavity.

### FIELD OF THE INVENTION

The invention relates to a method and an injection mould for producing a product comprising an insert having an edge which is to be reinforced and a plastic body which is injection-moulded onto the edge, wherein the plastic body surrounds an edge region of the insert on both sides and at the end face.

### BACKGROUND

Particularly in the case of containers and packing materials, there is a need to provide flat flexible parts along one edge with a plastic body which has a higher strength than the flat material.

For the most part in this case, the individual parts are manufactured separately and subsequently mechanically joined and possibly adhesively bonded to one another (e.g. FR2175094 or EP0453754).

A more efficient method is known from WO2015000797 for injection moulding a collar made from plastic directly onto a peripheral edge of an insert. To this end, the insert is inserted into a receptacle cavity of an injection mould. The edge region of the insert, which is to be overmoulded, is fixed in the injection mould by means of stationary and movable mould parts. The receptacle cavity in this case only extends over a few sub-regions on an underside of the edge region. In a first step, radially outwardly directed plastic webs are moulded on the underside of the edge region. In a second step, mould parts, between which the plastic webs had been formed, are lowered and a peripheral collar is formed on the underside of the edge region in a second injection. Then, a movable cavity-forming mould part on the upper side of the edge region is moved away and the exposed cavity is filled to form the peripheral collar on the upper side in a third injection.

The main problem when overmoulding the edge region lies in the materials to be overmoulded often not being dimensionally stable or not withstanding the pressure arising during the injection process and being pushed away in an uncontrolled manner by the melt. For this reason, the method from WO2015000797 is based on an injection mould, which is built in a complicated manner, having a multiplicity of mould parts which can be moved independently of one another and form cavities. These mould parts fix the edge region in a first step and gradually expose sub-regions of a cavity until the edge of the insert is completely overmoulded, i.e. at the end of the injection moulding process, the edge region is enclosed by the plastic body on both sides and over the end face.

### SUMMARY OF THE INVENTION

One object of the invention is to specify a method for producing a product made up of insert and plastic body injection-moulded thereon, which solves the problems of the prior art and ensures a reliable, strong connection between an insert and a plastic body that is injection-moulded thereon.

The method for producing a product comprising an insert having an edge which is to be reinforced and a plastic body which is injection-moulded onto the edge, the plastic body surrounding an edge region of the insert on both sides and at the end face, has the following steps: (a) providing an injection mould having a cavity, a cavity-forming wall being formed by a movable mould part which can be displaced during an injection process so that an additional volume of the cavity is exposed when the movable mould part is moved away; (b) inserting the insert into the injection mould so that the edge region to be overmoulded is arranged loose in the cavity of the injection mould, a first side surface of the edge region facing the movable mould part and a second side surface of the edge region facing away from the movable mould part; (c) injecting a polymer melt into the cavity at an injection point, so that the polymer melt first flows onto the second side surface of the edge region, which faces away from the movable mould part, and pushes the first side surface of the edge region, which faces the movable mould part, onto the movable mould part; (d) moving away the movable mould part and filling the exposed volume of the cavity in that the polymer melt flows along the first side surface of the edge region, which faces the movable mould part; (e) completing the injection process and removing the product from the mould.

Using the method, the edge region to be overmoulded does not have to be clamped between a plurality of movable mould parts which are subsequently pulled away gradually. The polymer melt can be controlled using the relative arrangement of the injection point, the edge region to be overmoulded and the movable mould part so that it first hits the side surface of the edge region which faces away from the movable mould part. In this case, the opposite side, i.e. the side facing the mould part is pushed and held against the mould part until the cavity is filled. Subsequently, the movable mould part is pulled away or moved away and the additional volume of the cavity exposed in the process is likewise filled with polymer melt.

The edge to be reinforced means a region of the insert which is narrow and extends over a certain length (e.g. an elongated edge of an insert). The edge region has two mutually opposite side surfaces and an end face. An edge region of this type often has insufficient stability and it is desirable to reinforce this in order for example to give the finished product more stability or other functions (e.g. fastening regions for further parts, such as lids, etc.). The edge region may for example be an upper peripheral edge of a cup. The insert is inserted into a receptacle of the injection mould so that the edge region comes to lie loosely in the cavity. That is to say, the edge region is not clamped between various parts of the injection mould. However, a side surface of the edge region can bear against a wall of the cavity. This cavity-forming wall is formed by the cavity-forming and movable mould part.

The method is also suitable for inserts which have a flexible edge region, for which there is the risk that the edge region is pushed away by the polymer melt and thus cannot undergo a strong and permanent connection to the plastic body. Accordingly, the insert may be designed to be thin-walled and/or flat.

Plastic means all materials capable of being injection moulded. These include conventional plastics capable of being injection moulded, but also novel materials capable of being injection moulded, which are made from natural substances and which will possibly no longer be designated as plastic in the future.

Preferably, prior to step (d), the injection of the polymer melt is continued until the cavity is approximately completely filled with the polymer melt.

In a few embodiments, the injection point for the polymer melt can be arranged on the side of the second side surface of the edge region of the inserted insert, so the injected polymer melt first contacts the insert at the second side surface and in the process pushes the first side surface of the edge region of the insert against the movable mould part. In this manner, the edge region can already be fixed to one side surface and the end face before, finally, a further part of the cavity is exposed and filled.

In a few embodiments, the edge region can deform during the injection of the polymer melt and adapt to a contour of the cavity in the region of the cavity-forming movable mould part.

In a few embodiments, the movable mould part can be movable substantially in one direction parallel to the first side surface.

In a few embodiments, during step e), a volume region of the cavity can be made smaller so that the polymer melt present therein is displaced and can flow into the exposed volume of the cavity. To this end, the injection mould can have a displaceable cavity-forming pressing part that can make a region of the cavity smaller during the injection moulding process or at the end of the injection, so polymer melt is displaced. The reduced volume region can be located in a region of the cavity which adjoins the exposed volume of the cavity or is at least fluidically directly connected thereto and is arranged on the side of the first side surface of the inserted insert, i.e. the flow path of the polymer melt into the exposed volume is shorter than the theoretical flow path to the second side surface of the edge region of the insert. In this manner, the direction of flow of the polymer melt which fills the exposed volume can be controlled so that the polymer melt does not push onto the second side surface of the insert and in the process create the risk of pushing the insert into the exposed volume as far as a wall of the cavity.

In a few embodiments, the injection point into the cavity for the polymer melt can be arranged on the side of the first side surface of the edge region of the inserted insert, wherein the edge region is hidden in such a protected manner behind the movable part in the direction of flow that the injected polymer melt can flow over the end face of the insert, first contacts the insert at the second side surface and in the process pushes the first side surface of the edge region of the insert against the movable mould part. In this case, it is possible to prevent the edge region of the insert from being entrained by the polymer melt.

In addition, the risk of the insert being pushed into the volume that is exposed later is reduced in that for the additional polymer melt, the flow path into the exposed volume is shorter than that to the second surface.

The injection point can be punctiform, slit-shaped or annular. There may also be a plurality of injection points present, in order to optimize the flow of the polymer melt and the filling of the cavity.

In a few embodiments, the cavity can extend behind the movable mould part on the side facing away from the inserted insert. Preferably, the cavity extends behind the movable mould part up to a length which corresponds approximately to the height of the edge region or the travel of the movable mould part, so that the additional volume can terminate flush with the cavity.

The movable mould part can in this case support the edge region until the cavity including the region behind the movable mould part is approximately completely filled. Subsequently, the movable mould part can be moved away and the exposed volume is filled as already described previously.

The advantage of an injection mould of this type or a method of this type is that even in the event of a partial pushing away of the edge region into the exposed volume, the edge region is nevertheless held by the plastic which is already present behind it and is enclosed by finished plastic body on three sides. A strong connection between insert and plastic body is ensured in this case.

The product can be a container having a container body or a container wall and a collar running around a container opening, wherein the container body or the container wall is formed by the insert and the container collar is formed by the plastic body. The peripheral collar may be an outwardly directed edge similar to a flange, an external thread or latching means for a container lid. The container lid can accordingly be a sealing film, a screw lid or a container lid with opposing latching means.

The insert can have a circular, oval or rectangular peripheral edge. A rectangular peripheral edge generally has rounded corners.

The insert can have a flexible, non-dimensionally-stable and/or thin-walled or flat edge region. It can be manufactured from paper, cardboard, a textile fabric, metal, plastic or laminates made from such materials. A few of the materials can be biologically degradable or compostable (industrially and in domestic compost). The thickness of the edge region can be 0.1 to 2 mm. The edge region can be a peripheral edge region, e.g. the edge of a cup-shaped container. The edge region of the insert can have a rough surface or a coating so that the plastic injection-moulded thereon can form a strong connection to the insert. The edge region can additionally also be provided with recesses or openings.

The plastic body that is injection-moulded thereon can be configured on the basis of the shape or the material such that it is stronger or more dimensionally stable than the edge region of the insert and forms a reinforcing plastic element. The plastic used can also be biologically degradable or compostable (industrially and in domestic compost) materials capable of being injection moulded. Generally in the present case, plastic means all known and future materials capable of being injection moulded.

The method can for example be used for producing a container comprising a container body which has an upper peripheral edge for forming an opening and a peripheral collar made from plastic which encloses the upper edge. The container body can in this case have a lower rigidity than the peripheral collar.

The invention further relates to an injection mould for carrying out the method for producing a product comprising an insert having an edge which is to be reinforced and a plastic body which is injection-moulded onto the edge, wherein the plastic body surrounds an edge region of the insert on both sides and at the end face. The injection mould comprises a cavity and is designed for inserting an insert. A cavity-forming wall is formed by a movable mould part which can be displaced during an injection process so that an additional volume of the cavity is exposed when the movable mould part is moved away. Furthermore, the injection mould is designed for inserting an insert in such a manner that the edge region of the inserted insert, which is to be overmoulded, is arranged loose in the cavity of the injection mould, wherein a first side surface of the edge region faces the movable mould part and a second side surface of the edge region faces away from the movable mould part.

The injection mould can be configured in such a manner that the first side surface already rests on the movable mould part after the insertion of the insert or the first side surface is only pushed against the movable mould part during the injection of the polymer melt.

In a few embodiments of the injection mould, the injection point for the polymer melt can be arranged in a region on the side of the second side surface of the edge region of the inserted insert. In this manner, the injected polymer melt can first contact the insert at the second side surface and in the process push the first side surface of the edge region of the insert against the movable mould part.

In a few embodiments of the injection mould, the injection mould can further have a movable pressing part or a second cavity-forming movable mould part which is designed in such a manner that it can make a volume region of the cavity smaller and in the process displace the polymer melt injected therein. In this manner, the displaced polymer melt can flow into the volume of the cavity exposed by the movement of the movable mould part. The reduced volume region can be located in a region of the cavity, which adjoins the exposed volume of the cavity or is at least fluidically directly connected thereto and is arranged on the side of the first side surface of the inserted insert.

In a few embodiments of the injection mould, the injection point into the cavity for the polymer melt can be arranged in a region on the side of the first side surface of the edge region of the inserted insert, wherein the movable mould part is designed in such a manner that the edge region can be hidden in a protected manner behind the movable part in the direction of flow of the polymer melt. In this manner, the injected polymer melt can flow over the end face of the insert and first contact the insert at the second side surface and in the process push the first side surface of the edge region of the insert against the movable mould part.

In a few embodiments of the injection mould, the cavity can extend behind the movable mould part on the side facing away from the inserted insert. Preferably, the cavity extends behind the movable mould part up to a length which corresponds approximately to the height of the edge region or the travel of the movable mould part, so that the additional volume can terminate flush with the cavity.

In a few embodiments, the movable mould part can be a flat or curved plate or a sleeve. The sleeve can be designed to be circular, oval or rectangular with round corners.

In a few embodiments, the movable mould part can have at least one cavity-forming slit. A cavity-forming slit of this type can already be filled with polymer melt before the movable mould part is moved away, so that the edge region of the insert in the region of the slit is already also partially held at the first side surface by the polymer melt before the movable mould part is moved away.

In a few embodiments, the injection opening can be designed in a punctiform, slit-shaped or annular manner.

### BRIEF DESCRIPTION OF THE DRAWINGS

The invention shall be explained in more detail in the following with reference to exemplary embodiments in connection with the drawing(s). In the figures:

FIGS. 1A-1D show a sectional illustration of an injection mould and FIGS. 1A-1D individual method steps of the method for producing a product from insert and plastic body injection-moulded thereon;

FIG. 2 shows a variant of the method step (d) from FIG. 1D;

FIGS. 3A and 3B show a view at FIG. 3A and a sectional illustration at FIG. 3B of a container made up of insert and plastic body with flange injection-moulded thereon;

FIGS. 4A-4C show a sectional illustration of a further variant of the injection mould and at FIGS. 4A-4C individual method steps of the method for producing a product from insert and plastic body injection-moulded thereon;

FIGS. 5A-5C show a sectional illustration of a further variant of the injection mould and at FIGS. 5A-5C individual method steps of the method for producing a product from insert and plastic body injection-moulded thereon;

FIG. 6 shows a sectional illustration of the injection mould having a peripheral plastic body for forming an external thread for a screw lid;

FIG. 7 shows a view of a movable mould part having slits;

FIGS. 8A and 8B show schematic illustrations with possible injection points.

### EMBODIMENTS OF THE INVENTION

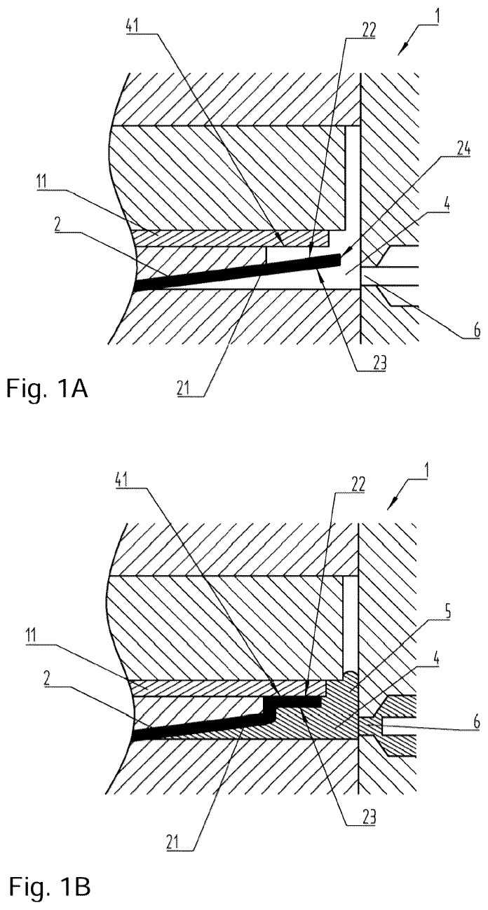

FIGS. 1A-1D show a sectional illustration of an injection mould in the region of the cavity. The injection mould 1 is used for producing a product comprising an insert 2 having an edge which is to be reinforced and a plastic body 3 which is injection-moulded onto the edge. The plastic body 3 surrounds an edge region 21 of the insert 2 on both sides and at the end face. The edge to be reinforced means a region of the insert which is narrow and extends over a certain length. The edge region has two mutually opposite side surfaces and an end face.

FIGS. 1A to 1D illustrate individual method steps of a method for producing a product made up of insert 2 and plastic body 3 injection-moulded thereon.

The injection mould 1 or a detail of the injection mould is shown in a closed state with inserted insert 2. The insert 2 has an edge region 21 which reaches into the cavity 4 of the injection mould 1. The edge region 21, which is to be overmoulded, is inserted loosely into the cavity. Outside of the edge region 21, which is to be overmoulded, the insert 2 is clamped into the injection mould 1 or clamped between components of the injection mould 1. The rest of the insert 2 is not illustrated. An end face 24, a first side surface 22 and a second side surface 23 of the edge region 21 are arranged inside the cavity 4.

The injection mould 1 has a cavity-forming movable mould part 11 which forms a wall 41 of the cavity 4. The movable mould part 11 can be moved away if required or during the injection moulding process and in the process expose an additional volume 4′ (e.g. visible in FIG. 1D) of the cavity 4.

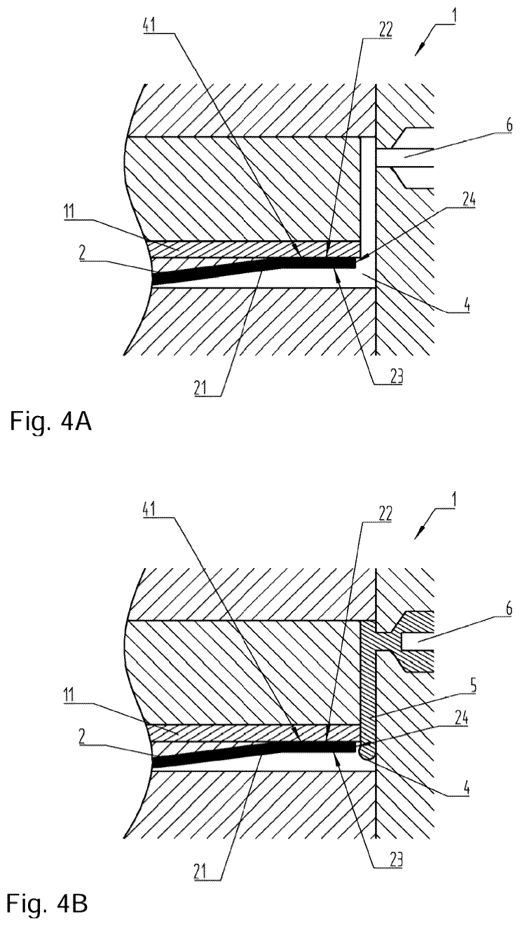

The injection mould 1 is configured such that the first side surface 22 faces the wall 41 which is formed by the movable mould part 11. In this case, the edge region 21 of the insert 2 can be arranged in the cavity 4 in a free-standing manner prior to the injection moulding process (as shown in FIG. 1A). Alternatively, the first side surface 22 of the edge region 21 can rest on the wall 41 of the movable mould part 11 (as shown in FIG. 4A).

In the embodiment shown in FIGS. 1A to 1D, an injection opening 6 of an injection nozzle for a polymer melt 5 of the plastic body 3 is arranged in such a manner that during injection, the polymer melt 5 first hits the second side surface 23 of the edge region 21 of the insert 2. In the process, the first side surface 22 of the edge region 21 is pushed against the wall 41 of the movable mould part 11, as is illustrated in FIG. 1B. In the course of the injection moulding process, approximately the entire cavity 4 is filled with the polymer melt 5 (FIG. 1C). Shortly before it is full, the movable mould part 11 is moved away (arrow A) and an additional volume 4′ of the cavity at the side of the first side surface 22 of the edge region 21 is exposed. This exposed volume 4′ is subsequently filled with polymer melt 5, so that the plastic body 3 encloses the edge region 21 of the insert 2 from three sides and is strongly connected thereto (FIG. 1D).

Subsequently, the injection mould can be opened and the product can be removed from the mould.

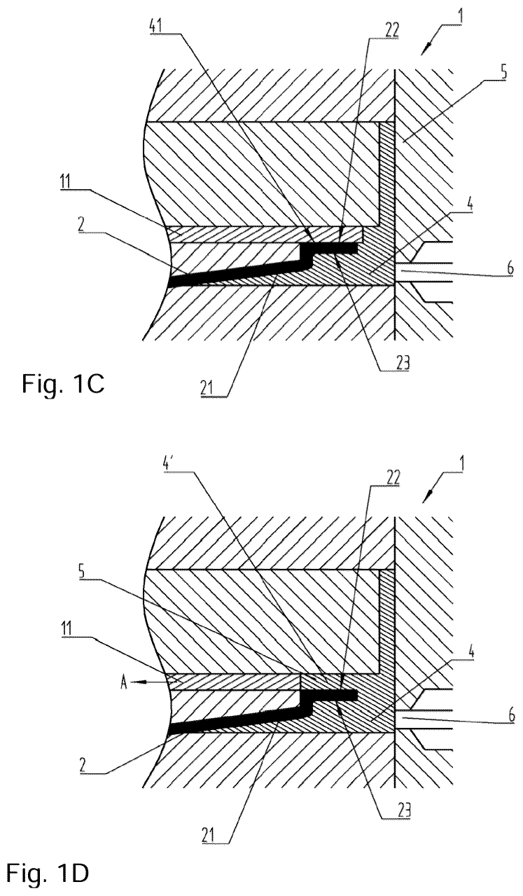

FIG. 2 shows a variant of the method step (d) from FIG. 1D. For this, the injection mould 1 has a displaceable pressing part 12 or a second cavity-forming movable mould part which in the embodiment shown can be moved in the opposite direction (arrow B) of the (first) movable mould part 11. During the moving away of the movable mould part 11 (arrow A), the pressing part 12 is moved in direction B and makes a region 4″ of the cavity 4 smaller. The polymer melt 5 displaced in this case flows into the volume 4′ of the cavity 4 that is exposed at the same time. An injection mould 1 constructed in such a manner and this method step are advantageous if the risk exists that the polymer melt 5 that is additionally injected in the method step according to FIG. 1D could push the edge region 21 of the insert 2 into the exposed volume 4′.

The reduced volume region 4″ can be located in a region of the cavity 4, which adjoins the exposed volume 4′ of the cavity 4 or is at least fluidically directly connected thereto and is arranged on the side of the first side surface 22 (cf. FIG. 2), i.e. the flow path of the polymer melt 5 into the exposed volume 4′ is shorter than the theoretical flow path to the second side surface 23 of the edge region 21 of the insert 2.

In addition, the flow direction of the polymer melt 5 can be influenced to some extent using the positioning of an end face 24 of the movable mould part 11. Thus, the mould part can for example be adjusted such that the end face 24 of the insert 21 terminates flush with the end face of the movable mould part 11 or protrudes slightly beyond the same. Vice versa, the end face of the movable mould part 11 can also protrude beyond the end face 24 of the insert 21, as shown in the figures.

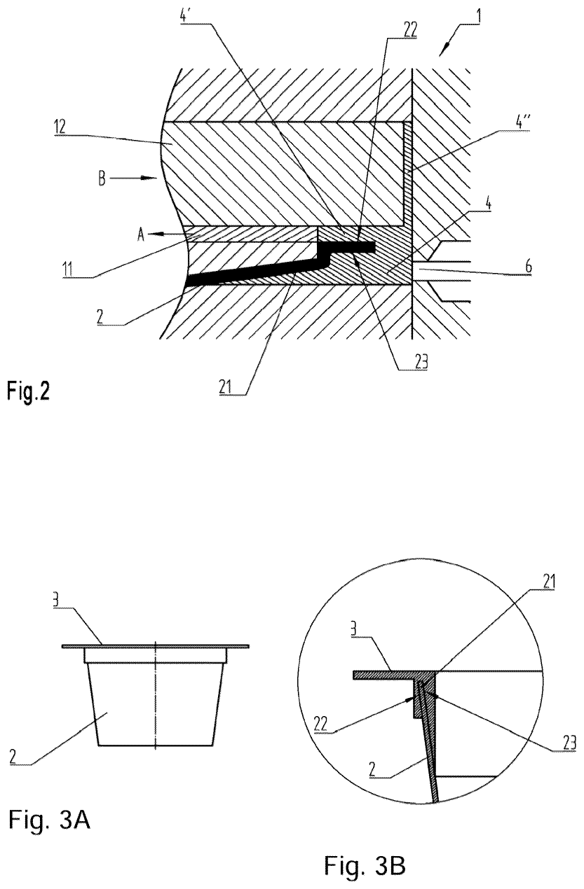

FIGS. 3A and 3B show a view at FIG. 3A and a sectional illustration at FIG. 3B of a container made up of insert 2 and plastic body 3 with flange injection-moulded thereon, which container can be produced using one of the methods described previously or described below. The insert 2 forms the cup-shaped container body and the plastic body 3 forms a peripheral collar having a radially outwardly directed flange. The plastic body 3 encloses the edge region 21 of the insert 2 from three sides and is strongly connected to the same.

Other products can likewise be produced using the methods. Thus, the insert can for example form a flat or curved wall. The edge region can be designed to be circular, oval or rectangular with rounded corners.

To produce a cup-shaped container, the injection opening can be configured to be punctiform or annular.

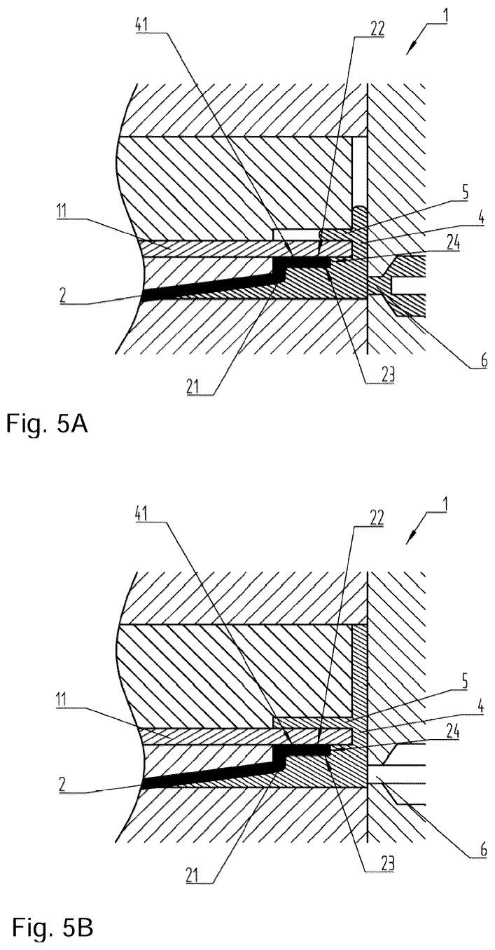

The plastic body 3 can for example, instead of the flange for a sealing film, also form an external thread for a screw lid (cf. FIG. 6) or latching means for a snap closure.

FIGS. 4A to 4C show an embodiment of an injection mould 1 in which, in contrast to the design of FIGS. 1A-1D, the injection opening 6 is arranged in a region of the cavity 4, which is located on the side of the first side surface 22 of the edge region 21 of the insert 2. With inserted insert 2, the end face 24 of the edge region 21 is hidden behind the movable cast component 11 in the direction of flow of the polymer melt 5.

Preferably, the first side surface 22 of the edge region 21 rests on the wall 41 which is formed by the movable mould part 11. During the injection of the polymer melt 5, the polymer melt flows over the end face 24 of the edge region 21 (FIG. 4B) and subsequently pushes the first side surface 22 of the edge region 21 onto the wall 41 of the movable mould part 11.

In the course of the injection moulding process, approximately the entire cavity 4 is filled with the polymer melt 5. Shortly before it is full, the movable mould part 11 is moved away (arrow A) and an additional volume 4′ of the cavity 4 at the side of the first side surface 22 of the edge region 21 is exposed. This exposed volume 4′ is subsequently filled with polymer melt 5, so that the plastic body 3 encloses the edge region 21 of the insert 2 from three sides and is strongly connected thereto (FIG. 4C).

In this embodiment also, a movable pressing part, as described under FIG. 2, can be used.

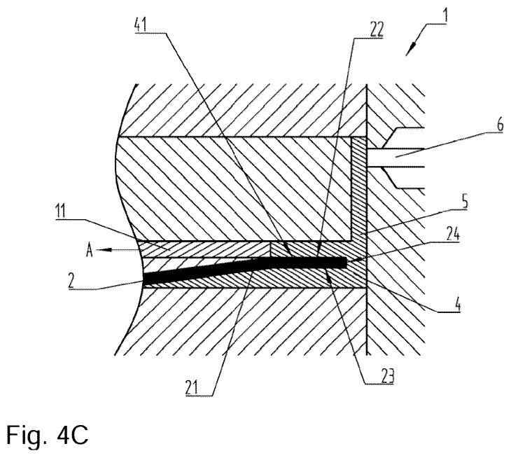

FIGS. 5A to 5C show an embodiment of an injection mould 1 in which, in contrast to the design of FIGS. 1A-1D, the cavity 4 additionally extends behind the movable mould part 11, i.e. on the side which faces away from the inserted edge region 21 of the insert 2. The movable mould part 11 in this case supports the edge region 21 until the cavity 4 including the region behind the movable mould part 11 is approximately completely filled. Subsequently, the movable mould part 11 is moved away and the exposed volume 4′ is filled as already described previously. Preferably, the cavity 4 extends behind the movable mould part 11 up to a length which corresponds approximately to the height of the edge region 21 or the travel of the movable mould part 11, so that the additional volume 4′ terminates flush with the cavity 4.

The advantage of an injection mould 1 of this type or a method of this type is that even in the event of a partial pushing away of the edge region 21 into the exposed volume 4′, the edge region is nevertheless held by the plastic which is already present behind it and is enclosed by finished plastic body 3 on three sides. A strong connection between insert 2 and plastic body 3 is ensured in this case.

In this embodiment also, a movable pressing part, as described under FIG. 2, can be used.

FIG. 6 shows an injection mould as can be used for a circular container, which, in contrast to the injection mould from FIG. 5C, does not form a peripheral collar with flange, which is injection-moulded on the insert, but rather forms a peripheral collar with external thread, which is injection-moulded on the insert.

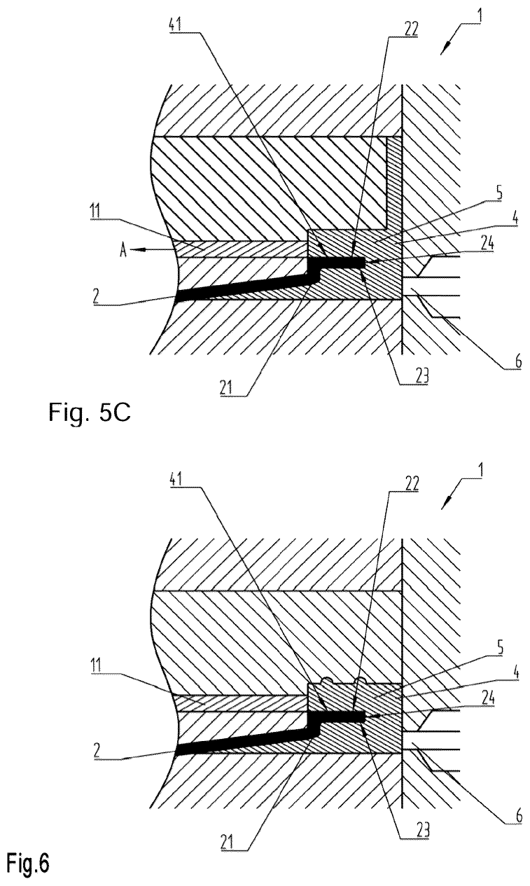

FIG. 7 shows a simplified schematic illustration of the movable mould part with a view of the side facing away from the insert. The movable mould part has at least one cavity-forming slit 13. A cavity-forming slit 13 of this type can already be filled with polymer melt before the movable mould part is moved away, so that the edge region 21 of the insert 2 in the region of the slit 13 is already also partially held at the first side surface 22 by the polymer melt before the movable mould part is moved away.

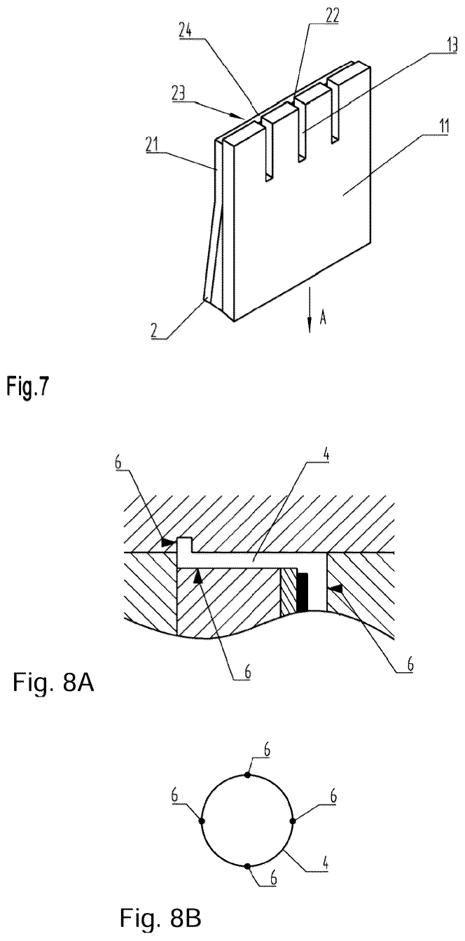

FIGS. 8A and 8B show schematic illustrations with different positionings of one or more injection points 6. In FIG. 8A, various further positions of a punctiform injection point 6 are illustrated as a filled triangle in each case. FIG. 8B schematically shows a round region of a cavity as a ring and a plurality of injection points 6 uniformly distributed over the circumference. Four injection points are shown. However, there may also be two mutually opposite injection points. Generally, a plurality of injection points 6 can be used in order to obtain an optimum melt distribution in the cavity.

### LIST OF REFERENCE NUMBERS

1 Injection mould
11 Movable mould part (cavity-forming)
12 Pressing part
13 Slit
2 Insert
21 Edge, edge region
22 First side surface of the edge region
23 Second side surface of the edge region
24 End face of the edge region
3 Plastic body
4 Cavity
4′ Exposed volume
4″ Reduced volume region
41 Wall
5 Polymer melt
6 Injection opening/injection nozzle/injection point

1-17. (canceled)

18. A method for producing a product comprising an insert having an edge which is to be reinforced and a plastic body which is injection-moulded onto the edge, the plastic body surrounding an edge region of the insert on both sides and at the end face, the method comprising:
a. providing an injection mould having a cavity, a cavity-forming wall being formed by a movable mould part which can be displaced during an injection process so that an additional volume of the cavity is exposed when the movable mould part is moved away;
b. inserting the insert into the injection mould so that the edge region to be overmoulded is arranged loose in the cavity of the injection mould, a first side surface of the edge region facing the movable mould part and a second side surface of the edge region facing away from the movable mould part;
c. injecting a polymer melt into the cavity at an injection point, so that the polymer melt first flows onto the second side surface of the edge region, which faces away from the movable mould part, and pushes the first side surface of the edge region, which faces the movable mould part, onto the movable mould part;
d. moving away the movable mould part and filling the exposed volume of the cavity in that the polymer melt flows along the first side surface of the edge region, which faces the movable mould part;
e. completing the injection process and removing the product from the mould.

19. The method according to claim 18, wherein the injection point for the polymer melt is arranged on the side of the second side surface of the edge region of the inserted insert, so the injected polymer melt first contacts the insert at the second side surface and in the process pushes the first side surface of the edge region of the insert against the movable mould part.

20. The method according to claim 18, wherein the movable mould part is movable substantially in one direction parallel to the first side surface.

21. The method according to claim 18, wherein during step d, a volume region of the cavity is made smaller so that the polymer melt present therein is displaced and flows into the exposed volume of the cavity.

22. The method according to claim 21, wherein the reduced volume region is located in a region of the cavity, which adjoins the exposed volume of the cavity or is at least fluidically directly connected thereto and is arranged on the side of the first side surface of the inserted insert.

23. The method according to claim 18, wherein the injection point into the cavity for the polymer melt is arranged on the side of the first side surface of the edge region of the inserted insert, wherein the edge region is hidden in such a protected manner behind the movable part in the direction of flow that the injected polymer melt flows over the end face of the insert and first contacts the insert at the second side surface and in the process pushes the first side surface of the edge region of the insert against the movable mould part.

24. The method according to claim 18, wherein the cavity extends behind the movable mould part on the side facing away from the inserted insert.

25. The method according to claim 18, wherein the product is a container, wherein the insert forms a container body or a container wall and the plastic body forms a peripheral collar having an outwardly directed edge similar to a flange, an external thread or latching means for a container lid.

26. An injection mould for carrying out the method according to claim 18, the injection mould comprising a cavity and being designed for inserting an insert,
wherein a cavity-forming wall is formed by a movable mould part which can be displaced during an injection process so that a volume of the cavity is exposed when the movable mould part is moved away and in that the injection mould is designed in such a manner for inserting an insert so that the edge region, which is to be overmoulded, is arranged loose in the cavity of the injection mould,
wherein a first side surface of the edge region faces the movable mould part and a second side surface of the edge region faces away from the movable mould part.

27. The injection mould according to claim 26, wherein the injection point for the polymer melt can be arranged in a region on the side of the second side surface of the edge region of the inserted insert.

28. The injection mould according to claim 26, wherein the injection mould further has a movable pressing part which is designed in such a manner that it can make a volume region of the cavity smaller and in the process displace the polymer melt injected therein.

29. The injection mould according to claim 28, wherein the reduced volume region is located in a region of the cavity, which adjoins the exposed volume of the cavity or is at least fluidically directly connected thereto and is arranged on the side of the first side surface of the inserted insert.

30. The injection mould according to claim 26, wherein the injection point into the cavity for the polymer melt is arranged in a region on the side of the first side surface of the edge region of the inserted insert, wherein the movable mould part is designed in such a manner that the edge region can be hidden in a protected manner behind the movable part in the direction of flow of the polymer melt.

31. The injection mould according to claim 26, wherein the cavity extends behind the movable mould part on the side facing away from the inserted insert.

32. The injection mould according to claim 26, wherein the movable mould part is a flat or curved plate or a sleeve.

33. The injection mould according to claim 26, wherein the movable mould part has at least one cavity-forming slit.

34. The injection mould according to claim 26, wherein the injection opening is designed in a punctiform, slit-shaped or annular manner.
